(19) United States
(12) Patent Application Publication
(10) Pub. No.: US 2025/0392248 A1
(43) Pub. Date: Dec. 25, 2025

(54) Hand-cranked photovoltaic mobile integrated trailer and power supply system thereof

(71) Applicant: Anhui Sharetronic Data Technology Co., Ltd., Hefei (CN)

(72) Inventors: Kangming GENG, Hefei (CN); Muming GE, Hefei (CN); Zhou YI, Hefei (CN); Ya HUANG, Hefei (CN); You XU, Hefei (CN)

(73) Assignee: Anhui Sharetronic Data Technology Co., Ltd., Hefei (CN)

(21) Appl. No.: 18/763,297

(22) Filed: Jul. 3, 2024

(30) Foreign Application Priority Data
Jun. 19, 2024 (CN) 2024107948598

(51) Int. Cl. H02S 10/40; B60P 3/00; B60Q 1/24; B60Q 5/00; B60S 9/02; H02J 7/35; H02S 30/20

(52) U.S. Cl. CPC H02S 10/40; B60P 3/00; B60Q 1/24; B60Q 5/00; B60S 9/02; H02J 7/35; H02S 30/20

(57) ABSTRACT

A hand-cranked photovoltaic mobile integrated trailer and a power system thereof, comprising a monitoring and lighting assembly, a lifting rod assembly, a chassis frame assembly, an adjustable photovoltaic assembly, a power system, and a storage box, wherein the monitoring and lighting assembly is placed at a top portion of the lifting rod assembly and comprises monitoring cameras, a lighting fixture, a sound amplification device, and a cloud computing data processing control box; the adjustable photovoltaic assembly comprises a photovoltaic bracket, photovoltaic panels, and a hand-cranked photovoltaic rotating support used to adjust support angles of the photovoltaic panels; the power system is installed in an electrical box and comprises a battery energy storage assembly, an MPPT controller for photovoltaic access, an AC/DC controller for mains power access, a DC/DC voltage stabilizing controller for supplying power to the monitoring and lighting assembly, and a DC/AC controller for emergency power supply.

### INCORPORATION BY REFERENCE

This application claims the benefit of priority from China Patent Application No. 2024107948598 filed on Jun. 19, 2024, the contents of which are hereby incorporated by reference in their entirety.

### TECHNICAL FIELD

The present invention relates to a hand-cranked photovoltaic mobile integrated trailer and a power system thereof.

### BACKGROUND TECHNOLOGY

In certain post-disaster emergency situations, it is necessary to monitor and illuminate specific areas for a period of time, which can be addressed by using mobile solar-powered equipment. Solar energy is received by photovoltaic panels, stored in batteries, and then used to power corresponding monitoring loads.

Currently, existing mobile trailers on the market have single functions. Some products can only be used as beacons, achieving only lighting function. Angles of some products' photovoltaic panels are non-adjustable, or adjustment structures thereof are complex, with narrow adjustable angle ranges. Meanwhile, power systems of these products do not have emergency capabilities.

### SUMMARY OF THE INVENTION

The purpose of the present invention is to provide a hand-cranked photovoltaic mobile integrated trailer that maximizes solar energy output by manually adjusting angles of photovoltaic panels. Simultaneously, the present invention introduces a power system that not only achieves mains charging but also enables mains power output, serving as an emergency power source.

Therefore, the present invention offers a hand-cranked photovoltaic mobile integrated trailer, comprising a monitoring and lighting assembly, a lifting rod assembly, a chassis frame assembly, an adjustable photovoltaic assembly, a power system, and a storage box, wherein the monitoring and lighting assembly is placed at a top portion of the lifting rod assembly, and during transportation is removed from the top portion of the lifting rod assembly and placed in the storage box, and the monitoring and lighting assembly comprises monitoring cameras, a lighting fixture, a sound amplification device, and a cloud computing data processing control box; the adjustable photovoltaic assembly comprises a photovoltaic bracket, photovoltaic panels, and a hand-cranked photovoltaic rotating support used to adjust support angles of the photovoltaic panels; and the power system is installed in an electrical box and comprises a battery energy storage assembly, an MPPT (Maximum Power Point Tracking) controller for photovoltaic access, an AC/DC controller for mains power access, a DC/DC voltage stabilizing controller for supplying power to the monitoring and lighting assembly, and a DC/AC controller for emergency power supply.

The present invention optimizes and expands functions of integrated trailers and can better adapt to emergency situations.

The present invention has following beneficial effects: first, the present invention utilizes most reliable adjustment mechanisms to achieve angle adjustment of photovoltaic panels by light; and second, a power system topology structure adopted by the present invention enables trailers to not only have safe and efficient power supply capabilities, but also have the function of emergency power supply.

In addition to the purposes, features and advantages described above, the present invention has other purposes, features and advantages. The present invention is further explained in detail by reference to figures below.

### BRIEF DESCRIPTION OF THE DRAWINGS

Drawings attached to the specification forming a part of the present invention are used to provide further understanding of the present invention, and schematic embodiments of the present invention and their descriptions are used to interpret the present invention and do not constitute undue qualification of the present invention. In the attached drawings:

FIG. 1 is a schematic diagram of a hand-cranked photovoltaic mobile integrated trailer of the present invention.

FIG. 2 is a diagram of a monitoring and lighting assembly.

FIG. 3 is a diagram of a lifting rod assembly.

FIG. 4 is a diagram of a frame assembly.

FIG. 5 is a diagram of an adjustable photovoltaic assembly.

FIG. 6 is a topological diagram of a power supply system.

### SPECIFIC EMBODIMENTS

The present invention is described in detail below with reference to the attached drawings and in conjunction with embodiments.

The present invention proposes a hand-cranked photovoltaic mobile integrated trailer that maximizes solar energy output by manually adjusting angles of photovoltaic panels. Simultaneously, the present invention introduces a power system that not only achieves mains charging but also enables mains power output, serving as an emergency power source.

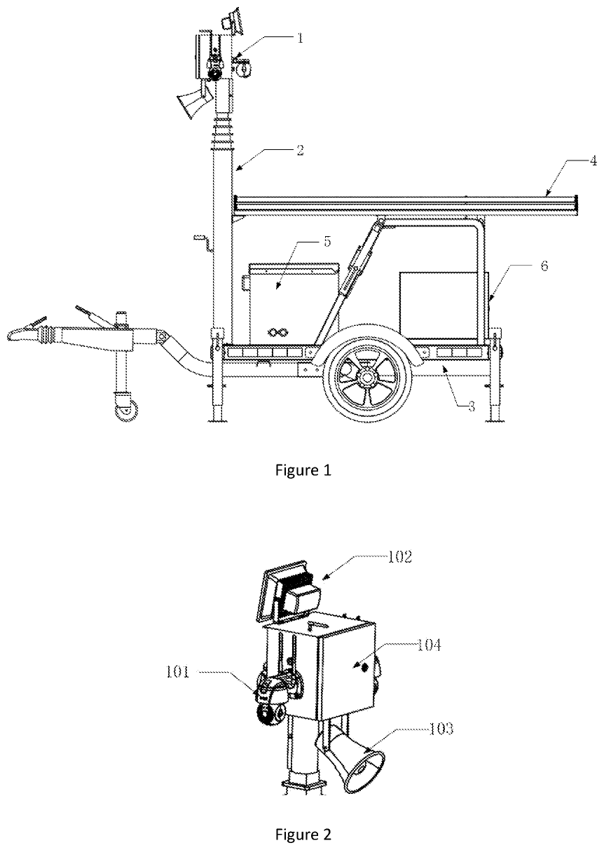

As shown in FIG. 1, a hand-cranked photovoltaic mobile integrated trailer of the present invention, comprises a monitoring and lighting assembly 1, a lifting rod assembly 2, a chassis frame assembly 3, an adjustable photovoltaic assembly 4, a power system 5, and a storage box 6.

As shown in FIG. 2, the monitoring and lighting assembly 1 comprises monitoring cameras 101, a lighting fixture 102, a sound amplification device 103, and a cloud computing data processing control box 104.

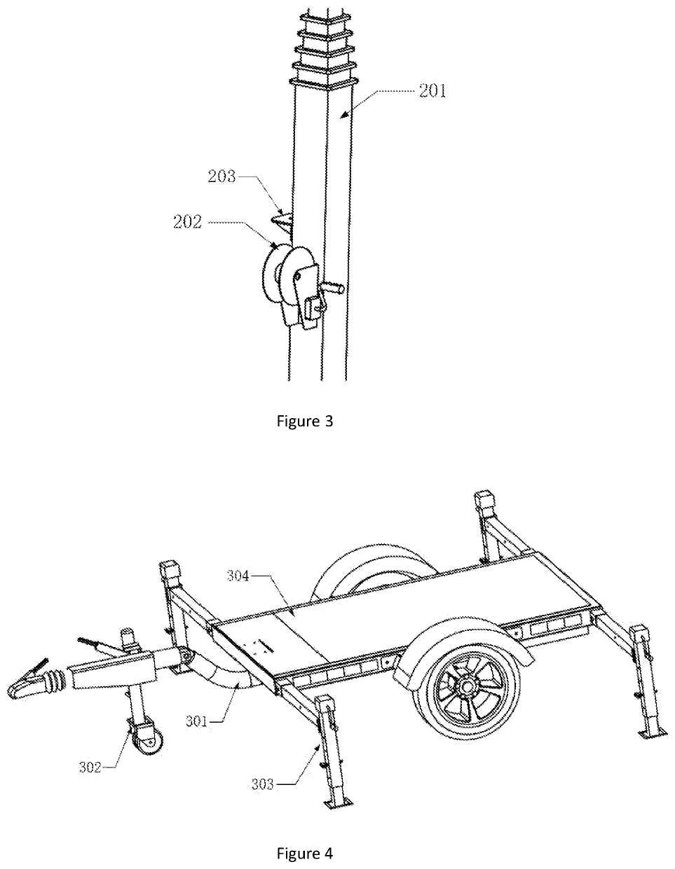

As shown in FIG. 3, the lifting pole assembly 2 comprises a lifting rod 201, a hand-cranked rotating rope structure 202, and a photovoltaic panel docking platform 203.

As shown in FIG. 4, the chassis frame assembly comprises a vehicle chassis 301, a guide wheel 302, four supporting legs 303, and a frame structure 304.

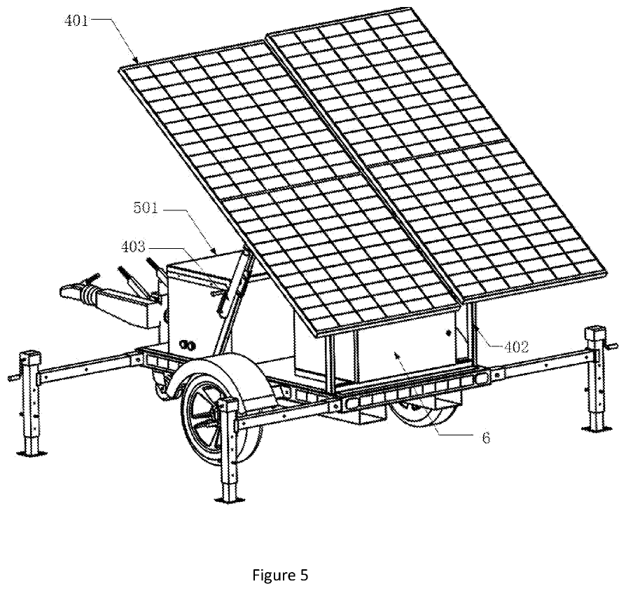

As shown in FIG. 5, the adjustable photovoltaic assembly 4 comprises photovoltaic panels 401, a photovoltaic bracket 402, and a hand-cranked photovoltaic rotating support 403.

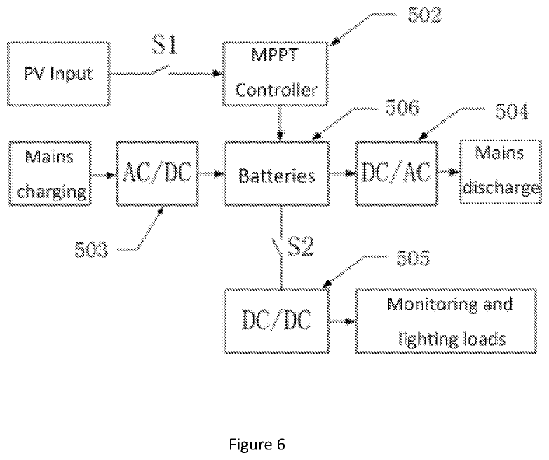

As shown in FIG. 6, a power system comprises an electrical box 501, an MPPT controller 502, an AC/DC controller 503, a DC/DC voltage stabilizing controller 504, a DC/AC controller 505, a battery energy storage assembly, a photovoltaic access switch S1, and a monitoring and lighting assembly power supply switch S2.

The monitoring and lighting assembly 1 of the present invention meets multi-directional monitoring requirements through the monitoring cameras 101, and achieves functions of lighting and sound amplification through the lighting fixture 102 and the sound amplification device 103. All data transmission of the present invention is stored in the cloud computing data processing control box 104. During the driving of the hand-cranked photovoltaic mobile integrated trailer of the present invention, the monitoring and lighting assembly 1 is disassembled and placed in the storage box 6.

The lifting rod assembly 2 and the monitoring lighting assembly 1 is connected via a quick-connect interface, and the lifting rod 201 is raised and lowered by the hand-cranked rotating rope structure 202, which comprises a self-locking function.

The chassis frame assembly 3 is fixed to the lifting rod assembly 2 by bolt connection. During driving, the chassis frame assembly 3 releases the guide wheel 302 and meanwhile retracts the four supporting legs 303; when the hand-cranked photovoltaic mobile integrated trailer is parked, the chassis frame assembly 3 retracts the guide wheel 302 and releases the four supporting legs 303 as supports.

The adjustable photovoltaic assembly 4 is fixed to the chassis frame assembly 3 by bolt connection, and the photovoltaic bracket 402 is adjusted in angle by the hand-cranked photovoltaic rotating support 403. According to actual lighting conditions, a rotation angle of 0\hat{ }90° with a horizontal plane is adjusted to maximize the utilization of photovoltaic energy; meanwhile, the photovoltaic panels 401 can be expanded left and right through the photovoltaic bracket 402 by utilizing the internal guide rail characteristics of the bracket, so as to receive more light energy.

The power supply system 5 is installed in the electrical box 501. The energy received by the photovoltaic panels is converted into maximum energy through the MPPT controller and input into batteries for energy storage. Then battery energy is connected to the DC/DC voltage stabilizing controller and safely and reliably output to loads of the monitoring and lighting assembly for monitoring and lighting use. Meanwhile, the batteries are connected to a set of the DC/AC controller and a set of AC/DC controller. In the absence of light, the AC/DC controller can be used to convert mains power supply into battery energy storage. The batteries can also convert energy into the same power supply as the mains power supply through the DC/AC controller, which can be regarded as an outdoor mobile power supply for users to use other loads. The power supply system 5 comprises two switches, namely the photovoltaic access switch S1 and the monitoring and lighting load access switch S2, which are introduced to external control panels, so that the user can use and shut down the power supply system by controlling the switches, and the control is safe and simple.

The hand-cranked photovoltaic mobile integrated trailer according to the present invention has a simple and reliable adjustment mechanism with high cost performance. Angles of the photovoltaic panels can be adjusted according to the light and the rotation angle adjustment of 0\hat{ }90° with the horizontal plane can be achieved to maximize the utilization of light energy and meet multi-directional monitoring and lighting requirements. Meanwhile, a topological structure of the power supply system is proposed, which not only has the ability to supply power safely and efficiently, but also has the function of serving as an emergency power supply.

The above are only embodiments of the present invention and are not intended to limit the present invention, which is subject to various changes and variations for those skilled in the art. Any modification, replacement, improvement, etc. made within the spirit and principles of the present invention shall be included in the scope of protection of the present invention.

1. A hand-cranked photovoltaic mobile integrated trailer, comprising a monitoring and lighting assembly, a lifting rod assembly, a chassis frame assembly, an adjustable photovoltaic assembly, a power system, and a storage box, wherein the monitoring and lighting assembly is placed at a top portion of the lifting rod assembly, and during transportation is removed from the top portion of the lifting rod assembly and placed in the storage box, and the monitoring and lighting assembly comprises monitoring cameras, a lighting fixture, a sound amplification device, and a cloud computing data processing control box; the adjustable photovoltaic assembly comprises a photovoltaic bracket, photovoltaic panels, and a hand-cranked photovoltaic rotating support used to adjust support angles of the photovoltaic panels; and the power system is installed in an electrical box and comprises a battery energy storage assembly, an MPPT controller for photovoltaic access, an AC/DC controller for mains power access, a DC/DC voltage stabilizing controller for supplying power to the monitoring and lighting assembly, and a DC/AC controller for emergency power supply.

2. The hand-cranked photovoltaic mobile integrated trailer according to claim 1, wherein the photovoltaic panels are arranged above the electrical box and the storage box, and are foldable in a transverse direction of the hand-cranked photovoltaic mobile integrated trailer to serve as roofs.

3. The hand-cranked photovoltaic mobile integrated trailer according to claim 1, wherein the monitoring cameras, the lighting fixture, the sound amplification device are arranged on the cloud computing data processing control box.

4. The hand-cranked photovoltaic mobile integrated trailer according to claim 1, wherein the chassis frame assembly comprises a vehicle chassis, a guide wheel, four supporting legs and a frame structure.

5. The hand-cranked photovoltaic mobile integrated trailer according to claim 1, wherein the lifting rod assembly comprises a lifting rod and a hand-cranked rotating rope structure, bottom end portions of the lifting rod are fixedly connected to the frame structure, and the hand-cranked rotating rope structure comprises a self-locking function and is used to manually lift the lifting rod.

6. The hand-cranked photovoltaic mobile integrated trailer according to claim 1, wherein the lifting rod assembly is arranged at a central position at a front end portion of the chassis frame assembly, the storage box is arranged at a rear portion of the vehicle, and a photovoltaic panel docking platform is provided on the lifting rod of the lifting rod assembly.

7. A power system of the hand-cranked photovoltaic mobile integrated trailer according to claim 1, comprising the photovoltaic panels, the battery energy storage assembly, the MPPT controller for photovoltaic access, the AC/DC controller for mains power access, the DC/DC voltage stabilizing controller for supplying power to the monitoring and lighting assembly, the DC/AC controller for emergency power supply, a photovoltaic access switch S1, and a monitoring and lighting assembly power supply switch S2.
